(19) United States
(12) Patent Application Publication
(10) Pub. No.: US 2012/0052458 A1
(43) Pub. Date: Mar. 1, 2012

(54) REMOVABLE ORTHODONTIC OR ORTHOPEDIC APPLIANCE WITH INLAID DESIGN PIECE AND THE METHOD OF CONSTRUCTION

(76) Inventor: Roger HARMAN, Wehrheim (DE)

(21) Appl. No.: 12/862,050

(22) Filed: Aug. 24, 2010

(51) Int. Cl. A61C 7/08

(52) U.S. Cl. 433/6

(57) ABSTRACT

The invention relates to a removable orthodontic or orthopedic appliance for wearing on a dentition comprising a metal wire and an acrylic polymer body, wherein at least one design piece is inlaid into the acrylic polymer body, and the design piece is die cut from an acrylate plate. The appliance can be an upper Hawley retainer, a lower Hawley retainer, a Bionator, a Schwarz appliance, or a Frankel appliance. The invention also relates to a method for producing such appliances.

### FIELD OF INVENTION

The invention relates to removable orthodontic or orthopedic appliances, and more particularly, to the appliances with at least one integrated design that is die cut from an acrylic based plate. The invention also relates to a method for producing such appliances.

### BACKGROUND OF THE INVENTION

Orthodontic retainers are custom-made devices, made usually of wires or clear plastic, which maintain teeth alignment after surgery or removal of fixed appliances.

One of the most popular forms of retainers is a Hawley retainer that includes palatal plate and a labial wire having ends embedded in the plastic palatal plate to keep the teeth in place. The palatal plate has a crowned shape that matches the curve of the hard, bony forward part of the palate or the roof of the mouth.

Retainers are usually removed and cleaned periodically and maybe removed during mealtimes. Some retainers are used primarily during sleep.

A long-standing problem of retainers is that they are often made of clear or colored plastic with highly visible wires. Their usually unattractive appearances very often discourage the application among users, especially among children.

To overcome the aforementioned problem, attempts have been made to develop attractive and individualized retainers with customer chosen motifs. One of the most common ways to produce such retainers is to first draw a design onto the retainer and then use a hand piece such as a knife to grind in the design. A concave space is formed that is subsequently filled with acrylic monomer liquid of different colors and copolymer powder. The addition of the monomer liquid and copolymer powder is repeated alternatively until a desired thickness is reached. Glitters can be added into to the space in the beginning or during the process to achieve a shiny appearance of the design. The retainer is put into a warm pressure pot to cure. Such method suffers from the drawback that the entire procedure is relative cumbersome. Moreover, only simple shapes and patterns can be designed into the retainer due to the shape of preformed retainer as well as the limit of handcraft.

U.S. Pat. No. 5,083,919, disclosed an alternative method to develop a personalized retainer that is to embed a design, such as a cartoon character imprinted on a design carrier consisting of metal, plastic, fabric or paper, inside the retainer. The method of making such orthodontic retainer includes the following steps: a) flowing colored liquid acrylic monomer material over a base of a mold cavity; b) covering the liquid monomer with a thin layer of co-polymer powder; c) placing a three dimensional, flexible design on the plastic; d) flowing liquid plastic monomer material over the design imprinted on a piece of metal foil, thin plastic, fabric cotton or paper; e) adding co-polymer powdered material in a mound on top of the design to embed the design; e) adding colored liquid plastic material and co-polymer into the palatal area and allowing the polymer to dry. The design carrier according to the patent is three-dimensional and flexible at room temperature, which means only thin pieces of metal, plastic, fabric and paper can be used, so that the carrier can be flexed and fit into the curved shape of the retainer during the addition of the monomer liquid and copolymer powder. One of the drawbacks of such methods is that, the vertical positions of the design pieces cannot always be accurately controlled. As a result, the plastic piece is either too close to the surface against the palate of the patient or too close to the surface facing the tongue and can easily undergo discoloring. In addition, the design, according to U.S. Pat. No. 5,083,919, is only confined to the pattern, shape and color of the figures that are printed on the design carrier.

Sheets, plates or disks of thermoshapable plastic with different colors and patterns have been utilized to generate dental retainers. A premade dental cast with a plastic plate placed on top of it is placed into a vacuum thermoshaping machine or a conventional pressure thermoshaping machine. The plastic plate is first heated to a suitable thermoshaping temperature and begins to sag slightly and then vacuum or pressure is applied until the plastic plate vacuum-pulled or pressure-pressed over the dental cast. The retainer formed is then cooled. This simplified procedure saves the cumbersome step of polymerization. However, the design of the retainer is confined solely to the color and pattern of the plastic plates, which leads to a lack of individuality of the retainer.

In view of the foregoing, it is an object of the present invention to develop an aesthetically pleasing orthodontic retainer with complex, delicate and robust designs, and to develop a simple method for producing such orthodontic retainers, which eliminates the above mentioned drawbacks.

### SUMMARY OF THE INVENTION

The invention achieves the aforesaid objects with, a removable orthodontic or orthopedic appliance for wearing on a dentition comprising a metal wire and an acrylic polymer body, wherein the acrylic polymer body is inlaid with at least one design piece, and the design piece is die cut from an acrylate plate that is preferably at least 2 mm thick.

The term “design piece” refers to a piece of material of a particular shape, color and pattern. The “design” originates not only from the pattern and color of the acrylate plate, from which the design piece is die cut from, but more importantly, from the template applied to cut the design. In other words, the shape of the design piece formed during the die cutting process is a very important aspect for the definition of the “design” in the sense of the current invention.

The orthodontic or orthopedic appliance of the present invention can be a variety of difference devices including upper and lower Hawley retainers, Bionators, Schwarz appliances, Frankel appliances, etc.

For the devices that are applied to the upper jaw of a patient, the acrylic polymer bodies are usually shaped to complementarily fit against the palate of the patient. These polymer bodies are generated using the conventional Spray-on technique, also called “salt and pepper” technique. Liquid acrylic monomer material, preferably methylmethacrylate monomer, is flowed over the base of a plaster mode, formed from a negative impression taken from the upper jaw of a patient. The liquid plastic monomer is then covered with a thin layer of co-polymer powder. As much copolymer powder as the liquid can absorb should be applied. The liquid plastic monomer and the co-polymer powder are applied alternatively until a desired thickness, which is usually 2 mm, is achieved.

The plastic bodies of other types of devices of the present invention, such as those applied on the lower dentition of a patient, are generated using similar methods.

The design, which is integrated into the palatal body, is die cut from an acrylate plate, preferably a thermoshapable plate. A break-resistant acrylic blank made of pure polymethyl-methacrylate is preferably utilized.

A Design piece, which is die cut from these thermoshapable acrylate plates, can be thermally bent to adopt a curved shape, so that it can fit better into the acrylic polymer body to be built. The plastic plates used for the designs should feature a different color and/or pattern from those of the maxillary palatal body and should have a thickness of at least 2 mm.

The present invention also relates to a method for producing the said removable orthodontic or orthopedic appliance, comprising at least the following steps:

a) constructing a plaster mold of the upper palate and dentition and/or lower dentition of a patient,

b) die cutting a design piece out of an acrylate plate,

c) fixing wire elements onto the plaster mold,

d) flowing liquid acrylic monomer material over the palatal base of the plaster mode and/or along the inner side of the lower and/or upper dentition, covering the liquid acrylic monomer with a thin layer of co-polymer powder,

e) placing the design piece onto the liquid and powder mixture in step d),

f) repeating step d) more than once with the same or different colored liquid and same or different colored co-polymer powder until a thickness of at least 2 mm of the plastic surrounding the design piece is achieved,

g) curing the appliance, and

h) polishing the inner concave surface of the appliance.

The plaster mold is usually first sealed with a separating medium in order to facilitate the separation of the appliance to be made from the mold.

The designs are stamped out of the plastic plates, preferably using high pressure water jet techniques. Depending on the templates used in the die cutting, the designs can be of various sophisticated shapes. Due to the application of the die cutting techniques, delicate designs with highly controlled and complex contour can be obtained, the sophistication of which cannot be achieved by handcrafted designs.

Preferably the monomer is methylmethacrylate with 0.01% pigment, 0.75% catalyst, 2% additives and 5% butandioldimethacrylate. The preferred powder is a co-polymer based on polymethylmethacrylate with a molecular weight 1.54-106, a peroxide content of 0.4-0.6%, and a central bead size of 63-90 my. According to the present invention, the design piece is not covered by the acrylic monomer or copolymer powder used to form the acrylic polymer body of the appliance. Rather its exterior forms part of the surface of the appliance facing the tongue.

As mentioned above, the acrylate plate for the design preferably features a different color and/or pattern from those of the maxillary palatal body and should have a thickness of at least 2 mm.

The retainer, Bionator, Schwarz appliance, or Frankel appliances generated is preferably cured in warm water at 40° C. for 20 minutes, and is subsequently subjected further to polishing and shining with a wet rag wheel and pumice. The surface is then brought to a gloss with a polishing compound, preferably aluminum oxide and chromium (III) oxide imbedded in waxes.

The design piece, after being die cut from a thermoshapable acrylate plate, is thermally bent, preferably at 125° C. (257° F.), before it is placed inside the plaster mold. It forms a firm connection with the rest of the acrylic polymer body during curing process.

The present invention further refers to the use of an acrylate plate, which is at least 2 mm thick, for generating a design that is integrated into an orthodontic or orthopedic appliance of acrylic base. Such acrylate plate is thermoshapable and has a thickness of at least 2 mm. Break-resistant acrylic blanks made of pure polymethylmethacrylate are preferably utilized.

One of the advantages of the methods for producing personalized dental appliances according to the present invention lies in that no polymerization step is involved for generating the decorating designs. The procedure for producing the dental devices according to the current invention is highly simplified. Instead of the quality being compromised, the orthodontic or orthopedic appliances produced according to the present invention contain highly delicate designs with sophisticated contour and patterns. Due to the thickness of the acrylate plate, the design piece is inlaid into the retainer without being covered by the acrylic polymer of the rest of the plastic body and forms an integral part of the device surface facing the tongue. The design is vivid and more durable than those in the prior art. The dental appliances according to the current invention promote their usage, especially among children, due to the unique aesthetic appearance.

The particular characteristics of the invention and the advantages deriving from it will be evident in greater detail from the description of a preferred embodiment depicted as a non-limiting example in the attached drawing, in which:

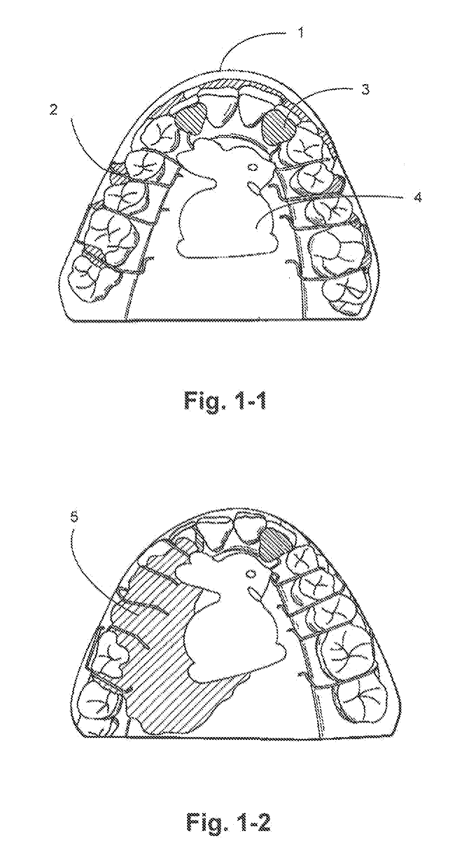

FIG. 1 shows two steps of the process for making a Hawley retainer.

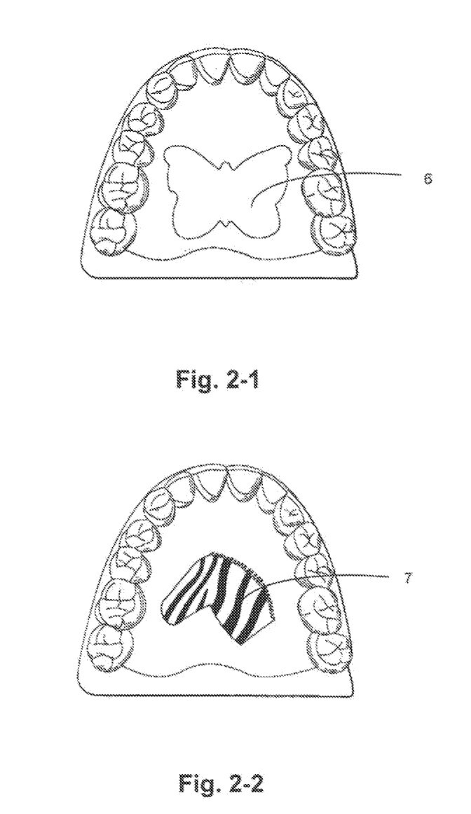

FIG. 2 shows the top view of two Hawley retainers produced according to the present invention.

In FIG. 1-1, a plaster mold 1 is a positive made of a negative of the maxillary arch, teeth and palate of a retainer user. Wire elements 2 are placed into the mold, with sticky wax 3 being used to hold the wires onto the plaster mold. A 2 mm thick design piece 4 in the shape of a rabbit, with its eye and mouth being painted out, is placed into the mold 1. As shown in FIG. 1-2, liquid plastic monomer and co-polymer powder 5 are added into the plaster mold to form the retainer.

For the purpose of demonstrating the invention, the inventor has quickly generated several retainers without wires. FIG. 2-1 shows a retainer with the design piece 6 in the shape of a butterfly. FIG. 2-2 shows a retainer inlaid with a design piece 7 in the shape of a horse head. The design piece is die cut from a black and white stripe patterned acrylate plate that fits well with the motif of a horse head. The saw shaped curve illustrating the fur on the back neck of the horse head exemplifies the sophistication of the design that can be achieved by the current invention.

1. (canceled)

2. The method according to claim 7, wherein the acrylate plate is at least 2 mm thick.

3-4. (canceled)

5. The method according to claim 7, wherein the acrylate plate used for the design piece features a different color or pattern from the maxillary palatal body.

6. (canceled)

7. A method for producing a removable orthodontic or orthopedic appliance according to claim 1, comprising at least the following steps:
a) constructing a plaster mold of the upper palate and dentition or lower dentition of a patient,
b) die cutting a design piece out of an acrylate plate,
c) fixing wire elements onto the plaster mold,
d) flowing liquid acrylic monomer material over the palatal base of the plaster mode or along the inner side of the lower or upper dentition of the plaster model and covering the liquid acrylic monomer with a thin layer of co-polymer powder,
e) placing the design piece onto the liquid and powder mixture in step d),
f) repeating step d) more than once with the same or different colored liquid and same or different colored co-polymer powder until a thickness of at least 2 mm of the plastic surrounding the design piece is achieved,
g) curing the appliance, and
h) polishing the inner concave surface of the appliance.

8. The method for producing a removable orthodontic or orthopedic appliance according to claim 7, wherein the method further comprises the step of high shining the retainer with a dry wheel rouge.

9. The method for producing a removable orthodontic or orthopedic appliance according to claim 7, wherein the design piece is die cut from a thermoshapable acrylate plate and is thermally bent before it is placed inside the plaster mold.

10. Use of an acrylate plate at least 2 mm thick for generating a design that is inlaid into a removable orthodontic or orthopedic appliance of acrylic base.

11. A removable orthodontic or orthopedic appliance for wearing on a dentition and made by the method of claims 7.
